(19) United States
(12) Patent Application Publication
(10) Pub. No.: US 2018/0052862 A1
(43) Pub. Date: Feb. 22, 2018

(54) LOG COLLECTION SYSTEM AND LOG COLLECTION METHOD

(71) Applicant: HITACHI, LTD., Tokyo (JP)

(72) Inventors: Takahiro HORI, Tokyo (JP); Makoto YAMAURA, Tokyo (JP)

(21) Appl. No.: 15/554,324

(22) PCT Filed: Oct. 26, 2015
(86) PCT No.: PCT/JP2015/080153

§ 371 Date: Aug. 29, 2017

(51) Int. Cl. G06F 17/30; G06F 11/34

(52) U.S. Cl. CPC G06F 17/30144; G06F 11/3476; G06F 17/30368; G06F 17/30185

(57) ABSTRACT

Proposed are an operation log collection system and an operation log collection method capable of reliably collecting required operation logs while protecting personal information. An operation log collection server determines a combination of a predetermined number of high-ranking business-related elements which are most frequently used during operation of the business file as a business file determination condition, and distributes, to each of the client terminals, the business file determination condition determined for each of the business files, and a client terminal determines whether a new file is a business file based on the business file determination condition distributed from the operation log collection server, and, when the new file is a business file, sends the operation logs related to the new file and the operation logs related to each of the business-related elements of the new file to the operation log collection server.

### TECHNICAL FIELD

The present invention relates to a log collection system and a log collection method, and can be suitably applied to a log collection system and a log collection method for collecting operation logs in an information processing system of companies and the like that introduced a business style referred to as BYOD (Bring Your Own Device) or BYCD (Bring Your Company's Device).

### BACKGROUND ART

In recent years, management software having a function of collecting operation logs generated in a client terminal used by a user, and comprehending the operations performed with the client terminal based on the collected operation logs has been developed, and is being widely used.

With an information processing system equipped with the foregoing management software, each client terminal is loaded with information collection software referred to as an agent. Each agent sends the operation logs generated in its client terminal to a management server loaded with management software. Moreover, the management software stores and manages the operation logs sent from each agent, and displays a list of the operation logs when requested by the user.

According to this kind of information processing system, the user can analyze the operation logs displayed on the management server so as to track the carrying in or carrying out of files or identify the client terminal that performed the operation, and it is thereby possible to conduct investigations regarding information leakage or take measures against information leakage.

### CITATION LIST

### Patent Literature

[PTL 1] Japanese Patent Application Publication No. 2014-99020

### SUMMARY OF THE INVENTION

### Problems to be Solved by the Invention

Meanwhile, in recent years, pursuant to the diversification of business environments, many companies are now introducing a business style referred to as BYOD where employees use their own information processing device such as a tablet terminal or a smartphone for business activities, or a business style referred to as BYCD where companies lease information processing devices that are also available for personal use.

Under the foregoing circumstances, for example, when BYOD or BYCD is introduced together with the foregoing management software, because operation logs related to personal file operations of employees that are unrelated to business activities will also be sent to the management server, there is a problem in that this is undesirable from the perspective of protecting the personal information of employees.

As a means for resolving the foregoing problem, for example, PTL 1 discloses an invention of providing, as the operation modes of the information processing device to be used in BYOD, a first policy of performing policy control based on the premise that the information processing device will be used at the user's home or the like for personal use, and a second policy of performing policy control based on the premise that the information processing device will be used at the office for business activities, and refraining from sending the event logs of events that occurred during the period that the first policy is being adopted to the event log management server, and only sending the event logs of events that occurred during the period that the second policy is being adopted to the event log management server.

Nevertheless, with PTL 1, the switching control of the operation mode (first policy or second policy) of the information processing device is performed based on the connected network or the location identified with a GPS (Global Positioning System). Thus, according to the invention disclosed in PTL 1, there is a problem in that the event logs of private file operations that are performed by the user in the office during lunch break or after work hours are sent to the management server, and the event logs of operations performed to a business-related file (this is hereinafter referred to as the “business file”) by the user using the information processing device outside the office are not sent to the event log management server.

Moreover, for example, considered may be a method of registering in advance the business files and folders, sites and email addresses to be used in business in the information processing device, and configuring the information processing device so that the operation logs are sent to the management server only when operations are performed in relation to the foregoing business files, folders, sites and email addresses. Nevertheless, according to this method, there is a problem in that the operation logs related to operations of a newly created business file, which was not registered in advance, cannot be collected by the management server.

The present invention was devised in view of the foregoing points, and an object of this invention is to propose an operation log collection system and an operation log collection method capable of reliably collecting required operation logs while protecting personal information.

### Means to Solve the Problems

In order to achieve the foregoing object, the present invention provides an operation log collection system including an operation log collection server and one or more client terminals and in which the operation log collection server collects operation logs generated in each of the client terminals, wherein the operation log collection server: periodically or randomly detects, based on the operation logs within a fixed period collected from each of the client terminals, all business files that were operated within the fixed period; detects, for each of the detected business files, all files and sites that were subject to a process in which a running time overlaps with a process of a file open period of the business file and in which sequential operations were performed between the processes during the file open period of the business file, as business-related elements of the business file; and determines for each of the business files, a combination of a predetermined number of high-ranking business-related elements which are most frequently used during operation of the business file as a business file determination condition, and distributes, to each of the client terminals, the business file determination condition determined for each of the business files, and wherein the client terminal: detects, based on the operation logs that were generated upon creation of a new file, all files and sites that were subject to a process in which a running time overlaps with a process of a file open period of the new file and in which sequential operations were performed between the processes during the file open period of the new file, as business-related elements of the new file; and does not send the operation logs to the operation log collection server when a combination of the business-related elements of the new file does not include a combination of the business-related elements configuring any one of the business file determination conditions distributed from the operation log collection server, and sends, to the operation log collection server, the operation logs related to the new file and the operation logs related to each of the business-related elements of the new file when a combination of the business-related elements of the new file includes a combination of the business-related elements configuring any one of the business file determination conditions distributed from the operation log collection server.

The present invention additionally provides an operation log collection method to be executed in an operation log collection system including an operation log collection server and one or more client terminals and in which the operation log collection server collects operation logs generated in each of the client terminals, comprising: a first step of the operation log collection server periodically or randomly detecting, based on the operation logs within a fixed period collected from each of the client terminals, all business files that were operated within the fixed period; a second step of the operation log collection server detecting, for each of the detected business files, all files and sites that were subject to a process in which a running time overlaps with a process of a file open period of the business file and in which sequential operations were performed between the processes during the file open period of the business file, as business-related elements of the business file; and a third step of the operation log collection server determining for each of the business files, a combination of a predetermined number of high-ranking business-related elements which are most frequently used during operation of the business file as a business file determination condition, and distributing, to each of the client terminals, the business file determination condition determined for each of the business files; a fourth step of the client terminal detecting, based on the operation logs that were generated upon creation of a new file, all files and sites that were subject to a process in which a running time overlaps with a process of a file open period of the new file and in which sequential operations were performed between the processes during the file open period of the new file, as business-related elements of the new file; and a fifth step of the client terminal not sending the operation logs to the operation log collection server when a combination of the business-related elements of the new file does not include a combination of the business-related elements configuring any one of the business file determination conditions distributed from the operation log collection server, and sending, to the operation log collection server, the operation logs related to the new file and the operation logs related to each of the business-related elements of the new file when a combination of the business-related elements of the new file includes a combination of the business-related elements configuring any one of the business file determination conditions distributed from the operation log collection server.

According to the operation log collection system and the operation log collection method of the present invention, it is possible to determine whether or not a new file is a business file with a certain level of accuracy, and the operation log collection server can appropriately collect only the operation logs related to the business file and its business-related elements.

### Advantageous Effects of the Invention

According to the present invention, it is possible to realize an operation log collection system and an operation log collection method capable of reliably collecting required operation logs while protecting personal information.

### BRIEF DESCRIPTION OF DRAWINGS

FIG. 1 is a block diagram showing a schematic configuration of the operation log collection system according to this embodiment.

FIG. 2 is a conceptual diagram showing a configuration example of the operation log-related definition table.

FIG. 3 is a conceptual diagram showing a configuration example of the operation log database.

FIG. 4 is a conceptual diagram showing a configuration example of the business file list.

FIG. 5 is a conceptual diagram explaining the processing contents to be performed by the operation log collection server in the operation log collection method according to this embodiment.

FIG. 6 is a conceptual diagram showing a configuration example of the number of appearances counter table.

FIG. 7 is a conceptual diagram showing a configuration example of the business file determination condition list.

FIG. 8 is a conceptual diagram explaining the processing contents to be performed by the client terminal in the operation log collection method according to this embodiment.

FIG. 9 is a conceptual diagram showing a configuration example of the business environment management table.

FIG. 10 is a conceptual diagram showing a configuration of the business file determination condition exclusion element management table.

FIG. 11 is a schematic diagram schematically showing a configuration example of the business environment registration screen.

FIG. 12 is a schematic diagram schematically showing a configuration example of the business environment display screen.

FIG. 13 is a schematic schematically showing a configuration example of the business file determination reason display screen.

FIG. 14 is a schematic schematically showing a configuration example of the business file determination condition exclusion element registration screen.

FIG. 15 is a schematic schematically showing a configuration example of the warning screen.

FIG. 16 is a flowchart showing a processing routine of the business file determination condition list distribution processing.

FIG. 17 is a flowchart showing a processing routine of the business file determination processing.

### DESCRIPTION OF EMBODIMENTS

An embodiment of the present invention is now explained in detail with reference to the appended drawings.

### (1) CONFIGURATION OF LOG COLLECTION SYSTEM

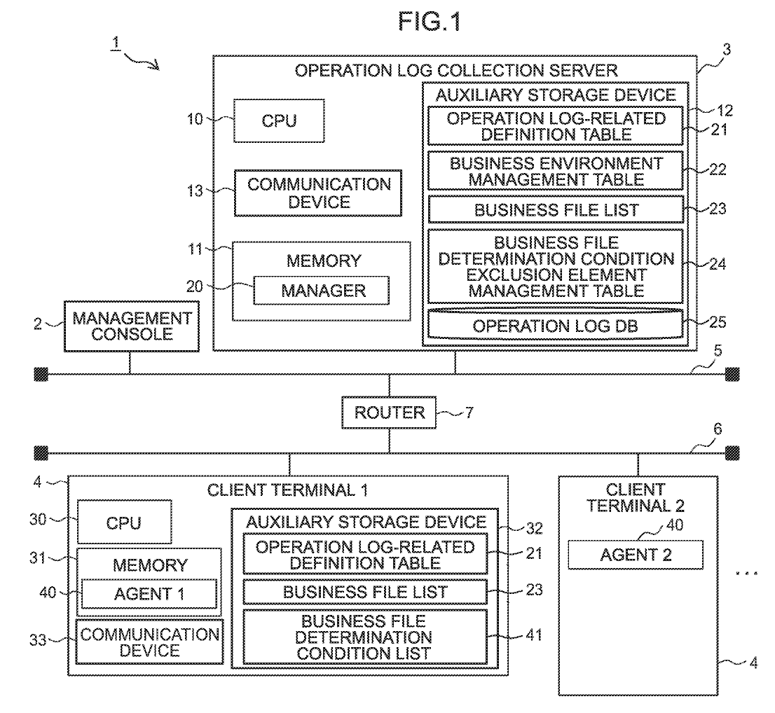

In FIG. 1, reference numeral 1 represents the overall operation log collection system 1 according to this embodiment. The operation log collection system 1 configures a part of the information processing system installed in companies and the like that have introduced BYOD or BYCD, and is configured by comprising a management console 2, an operation log collection server 3 and a plurality of client terminals 4.

The management console 2 and the operation log collection server 3 are connected to a first network 5 configured from a LAN (Local Area Network) or the internet, and each client terminal 4 is connected to a second network 6 configured from a LAN or a wireless LAN. The first and second networks 5, 6 are connected via a router 7.

The management console 2 is a computer device that is used by a system administrator for managing the operation log collection server 3, and is configured, for example, from a personal computer, a workstation or a mainframe. The system administrator can use the management console 2 and perform various types of settings in the operation log collection server 3.

The operation log collection server 3 is a general-purpose server device with a function of collecting the operation logs of various types of operations performed by the users in the respective client terminals 4, and is configured by comprising information processing resources such as a CPU (Central Processing Unit) 10, a memory 11, an auxiliary storage device 12 and a communication device 13.

The CPU 10 is a processor that governs the operational control of the overall operation log collection server 3. The memory 11 is configured, for example, from a nonvolatile semiconductor memory, and is mainly used for temporarily storing programs and data. The manager 20 described later is retained by being stored in the memory 11.

The auxiliary storage device 12 is configured, for example, from a large capacity nonvolatile storage device such as a hard disk device or an SSD (Solid State Drive), and is used for retaining various types of programs and various types of data for a long period. In the case of this embodiment, the auxiliary storage device 12 stores an operation log-related definition table 21, a business environment management table 22, a business file list 23, a business file determination condition exclusion element management table 24 and an operation log database 25.

The communication device 13 is configured, for example, from an NIC (Network Interface Card), and performs protocol control when the operation log collection server 3 communicates with the respective client terminals 4 via the first network 5, the router 7 and the second network 6.

The client terminal 4 is a computer terminal to be used for business activities which is owned by the user (employee or the like), or a computer terminal supplied by the company and in which personal use is allowed, or a computer terminal to be used only within the company, and is configured, for example, from a tablet terminal or a laptop personal computer. The client terminal 4 is configured by comprising information processing resources such as a CPU 30, memory 31, an auxiliary storage device 32 and a communication device 33 in the same manner as the operation log collection server 3.

The CPU 30 is a processor that governs the operational control of the overall client terminal 4. The memory 31 is configured, for example, from a nonvolatile semiconductor memory, and is mainly used for temporarily storing programs and data. The agent 40 described later is retained by being stored in the memory 31.

The auxiliary storage device 32 is configured, for example, from a hard disk device or an SSD, and is used for retaining various types of programs and various types of data for a long period. The operation log-related definition table 21, the business file list 23 and the business file determination condition list 41 described later are retained by being stored in the auxiliary storage device 32. The communication device 33 is configured from an NIC or the like, and performs protocol control when the client terminal 4 communicates with the operation log collection server 3 via the second network 6, the router 7 and the first network 5.

In the operation log collection system 1, when specific operations such as log-in/log-out and file open/save are performed, the client terminal 4 generates operation logs of a predetermined format including information such as the name of the user who performed the operation, date/time that the operation was performed, and type of operation performed (operation type), and, among the generated operation logs, sends the operation logs of predetermined operation types to the operation log collection server 3 as described later. Subsequently, the operation log collection server 3 stores the operation logs sent from the respective client terminals 4 in the operation log database 25 retained in the auxiliary storage device 12, and thereby manages the stored operation logs.

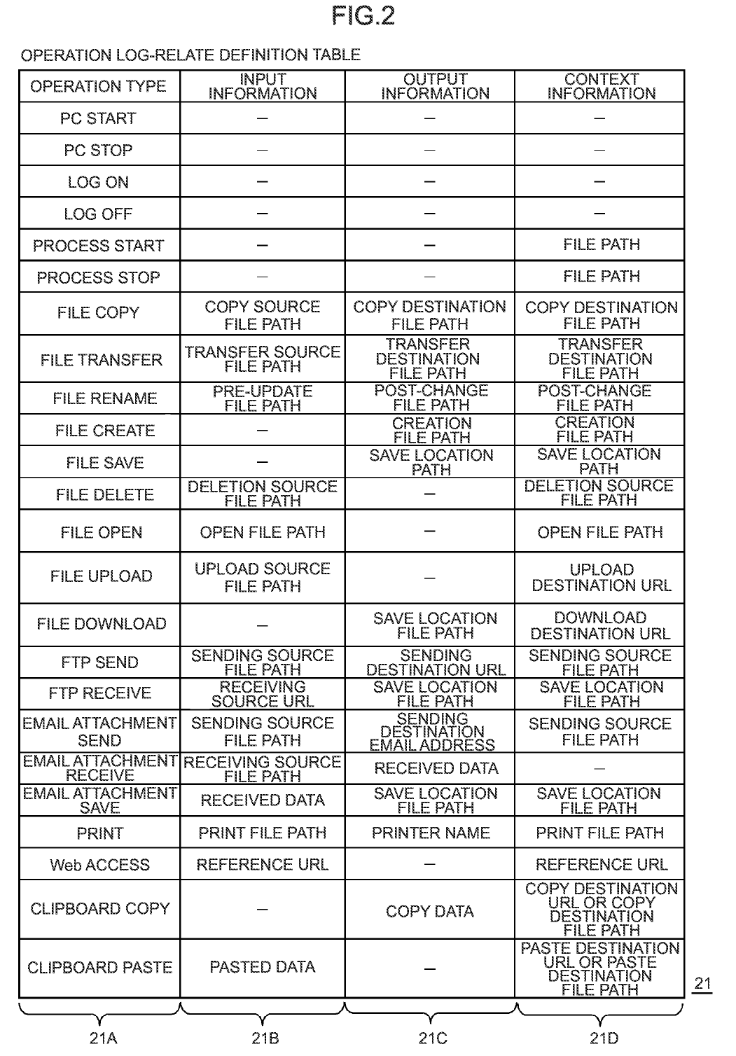

As a means for generating the operation logs of specific operations performed in the respective client terminals 4, each client terminal 4 retains the operation log-related definition table 21 shown in FIG. 2 in the auxiliary storage device 32 (FIG. 1). The operation log-related definition table 21 in which the operation types of operation logs to be generated in the client terminal 4 and the various types of information (input information, output information and context information) to be stored in the operation logs regarding the operation type are defined in advance, and is configured by comprising, as shown in FIG. 2, an operation type column 21A, an input information column 21B, an output information column 21C and a context information column 21D.

The operation type column 21A stores the types of operations for which operation logs should be generated by the client terminal 4 such as the start/stop, log-on/log-off, file copy or file creation of the client terminal 4. The input information column 21B stores information (input information) representing the input source of information when the corresponding operation involves the input of some type of information, and the output information column 21C stores information (output information) representing the output source of information when the corresponding operation involves the output of some type of information. The context information column 21D stores information (context information) related to the operation target of the corresponding operation.

Note that the operation logs generated by the respective client terminals 4 also store, in addition to the operation type, input information, output information and context information described above, the date/time that the operation was performed (operation date/time), the terminal name of the client terminal that performed the operation, the user name of the user who performed the operation (more accurately, the user who is logged-in at that time), the process name of the process related to the operation, and the process ID assigned to the process.

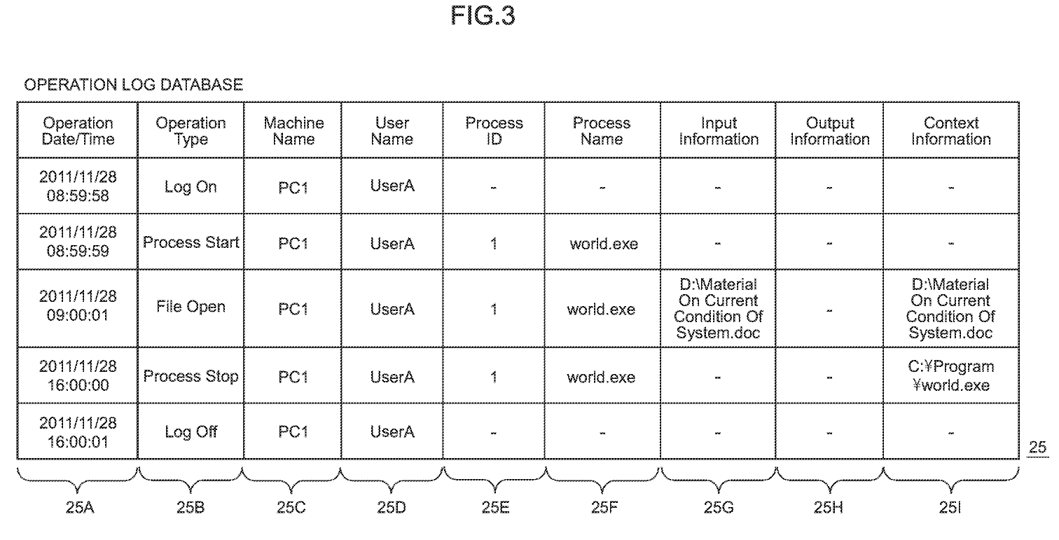

Meanwhile, FIG. 3 shows a configuration example of the operation log database 25 stored in the auxiliary storage device 12 of the operation log collection server 3. The operation log database 25 is a database that is used by the operation log collection server 3 for retaining and managing the operation logs that are sent from the respective client terminals 4, and is configured by comprising, as shown in FIG. 3, an operation date/time column 25A, an operation type column 25B, a machine name column 25C, a user name column 25D, a process ID column 25E, a process name column 25F, an input information column 25G, an output information column 25H and a context information column 25I.

The operation date/time column 25A, the operation type column 25B, the machine name column 25C, the user name column 25D, the process ID column 25E, the process name column 25F, the input information column 25G, the output information column 25H and the context information column 25I respectively store corresponding information among the operation date/time, the operation type, the client terminal name, the user name, the process ID, the process name, the input information, the output information and the context information stored in the operation logs as described above.

### (2) OPERATION LOG COLLECTION METHOD ACCORDING TO THIS EMBODIMENT

The operation log collection method to be performed in the operation log collection system 1 when the operation log collection server 3 collects the operation logs from the respective client terminals 4 is now explained. The operation log collection method is a method for the operation log collection server 3 to only collect, among the operation logs generated in the respective client terminals 4, the operation logs related to the operation of a business file, and, when another file or a site is accessed during the operation of the business file in relation to that business file, the operation logs related to such access. Note that, in the ensuing explanation, the expression “operation of a business file” refers to an operation including a file path of the any one of the business files in the input information column 21B, the output information column 21C and the context information column 21D of FIG. 2, and, specifically, all operations excluding “Web access” among the operation types from “file copy” to “clipboard paste” of FIG. 2 correspond to an “operation of a business file”. The reason why the operation log collection target was limited to operations related to business files is because business file-related operations are the cause of most information leakage incidents, and are operations that can be tacked using operation logs.

In effect, with the operation log collection system 1, the system administrator can use the management console 2 (FIG. 1) to register the business environment in the operation log collection server 3. Here, the term “business environment” is, for instance, an internal IP (Internet Protocol) address of an internal business file sharing folder to be used only within the company, within a business division, or within an internal business group, a URL (Uniform Resource Locator) of an internal file sharing site, or a business email address, and refers to an IP address, a URL of a site or an email address that will only be used for business, and, generally speaking, will not be used for personal use.

Meanwhile, the operation log collection server periodically (for instance, every month to every three months) refers to the operation logs of a most recent fixed period (for instance, one year) registered in the operation log database 25 based on the business environment registered in the manner described above, and detects all business files that were operated during the foregoing period. In this embodiment, files that were downloaded from the business environment, files that were uploaded to the business environment, files that were attached to the email address registered as a business environment, and files created by dedicated internal client terminals 4 are defined as business files. Accordingly, the operation log collection server 3 detects all such files as business files.

Specifically, the operation log collection server 3 refers to the input information, the output information and the context information of the respective operation logs stored in the input information column 25G and the output information column 25H of the operation log database 25 described above with reference to FIG. 3, and detects all files stored in or read from the business file sharing folder of an internal IP address registered as a business environment, all files downloaded from or uploaded to the internal file sharing site of a URL registered as a business environment, and all files attached to emails with a business email address set as a business environment as the destination or sender as business files. Furthermore, the operation log collection server 3 refers to the machine name column 25C (FIG. 3) of the operation log database 25, and detects files created by the dedicated internal client terminals 4 as business files.

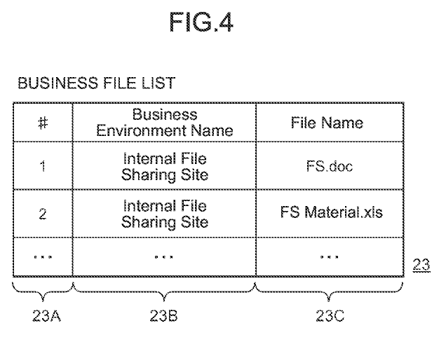

Subsequently, the operation log collection server 3 creates a business file list 23 as shown in FIG. 4 which registers all of the detected business files. The business file list 23 is configured by comprising a business file ID column 23A, a business environment name column 23B and a file name column 23C, and the business file ID column 23A stores the identifier (business file ID) that is assigned to the corresponding business file and which is unique to that business file. The business environment name column 23B stores the business environment name of the business environment from or to which the corresponding business file was downloaded or uploaded, and the file name column 23C stores the file name of the business file.

Subsequently, the operation log collection server 3 selects one business file among the business files registered in the business file list 23, and, among the operation logs (those listed on the left side of FIG. 5) of processes in which the running period overlaps with the file open period of the business file (period from the time that the file is opened to the time that the file is closed), acquires all operation logs including a file name and a site URL as related operation logs from the operation log database 25.

Moreover, the operation log collection server 3 groups the thus acquired related operation logs of the business file into groups (these are hereinafter referred to as the “related operation log groups”) RG having the same process ID (refer to the right side of FIG. 5), and respectively detects the files and sites that are subject to the corresponding process for each related operation log group RG. The operation log collection server 3 thereby detects all files and/or sites that were accessed during the operation of that business file.

Furthermore, the operation log collection server 3 detects as business-related elements, among the files and sites detected as described above, the files and sites that are subject to the process in which sequential operations (operations that were continuously performed for a fixe period mutually between processes such as the switching of screens with the business file) were performed with a process during the file open period of the selected business file.

Here, FIG. 5 shows an example of an operation log that is generated upon the creation of a business file named “FS.doc” uploaded to an internal file sharing site having a URL of “https://hatachi.com” as a business environment. Note that, in FIG. 5, “exces.exe” represents an EXE file of spreadsheet software (“exces”), “world.exe” represents an EXE file of document production software (“world”), and “explo.exe” represents an EXE file of internet browsing software (“explo”).

In this example, after logging in, in order to create the foregoing business file name “FS.doc”, the user referred to a previously created file named “FS Material.xls”, and browsed the website having a URL of “https://msdn.micro.com”. Moreover, after creating the business file named “FS.doc”, the user browsed a recreational website, and then logged off.

In the foregoing case, because the processes in which the running period overlaps with the file open period of the business file named “FS.doc” are only the process when the file named “FS Material.xls” was opened and the process when the website having a URL of “https://msdn.micro.com” was browsed, the operation logs of these two processes are acquired, and these two operation logs are respectively grouped as a related operation log group RG. Moreover, for both the process when the file named “FS Material.xls” was opened and the process when the website having a URL of “https://msdn.micro.com” was browsed, the screen was switched with the process of the business file named “FS.doc”, and sequential operations with the process of the business file were performed. Accordingly, in this example, the file named “FS Material.xls” and the website having a URL of “https://msdn.micro.com” are detected as the business-related elements of the business file named “FS.doc”.

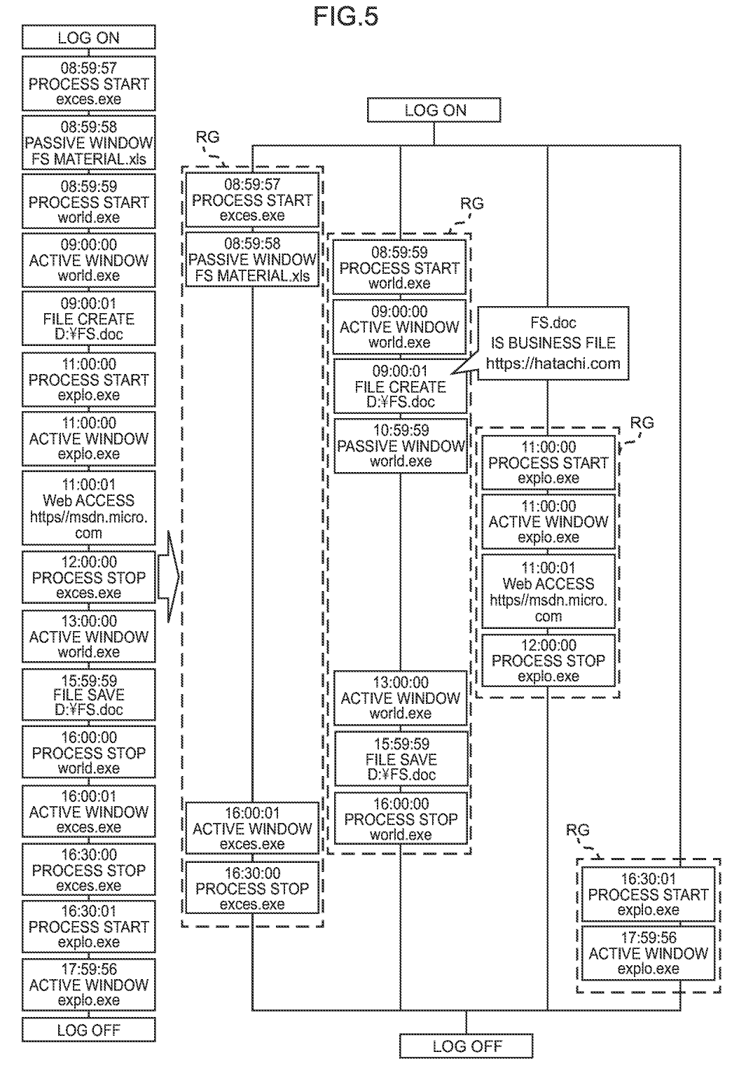

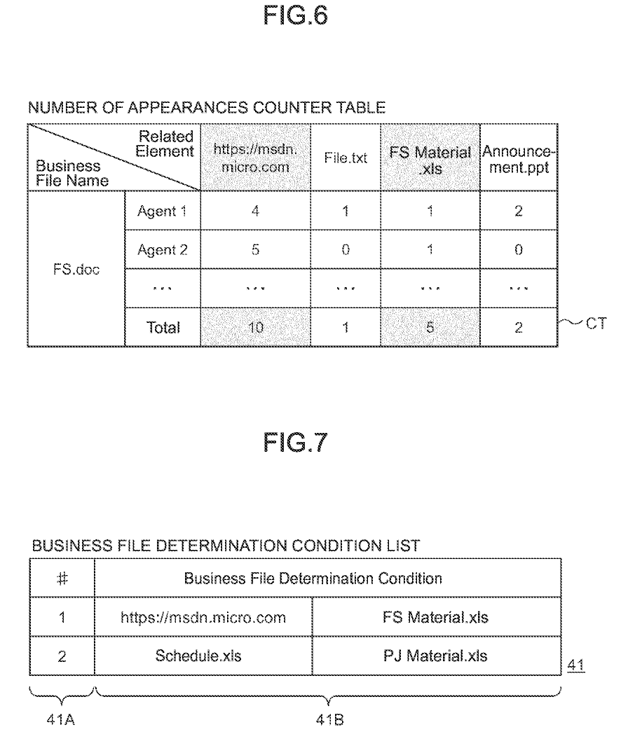

The operation log collection server 3 performs the foregoing processing regarding all business files registered in the business file list 23. Here, the operation log collection server 3 creates a number of appearances counter table CT as shown in FIG. 6 for each business file, and respectively counts the number of appearances of each of the extracted business-related elements.

When the operation log collection server 3 completes the execution of the foregoing processing regarding all business files registered in the business file list 23, the operation log collection server 3 determines for each business file, as a business file determination condition of that business file, a combination of a predetermined number of high-ranking (for instance, two) business-related elements in which the number of appearances is greatest.

For example, FIG. 6 shows an example where, with regard to the business file named “FS.doc”, the site having a URL of “https://msdn.micro.com”, the file named “File.txt”, the file named “FS Material.xls”, and the file named “Announcement.ppt” have been detected as the business-related elements by the respective client terminals 4 each loaded with an agent 40 of “Agent 1”, “Agent 2”, In the foregoing case, a combination of the website having the URL of “https://msdn.micro.com” which has the most number of appearances among the foregoing four business-related elements (number of appearances is “10” times), and the file having a file name of “FS Material.xls” with the next most number of appearances (number of appearances is “5” times) is determined as the business file determination condition of the business file named “FS.doc”. The two business-related elements configuring the thus determined business file determination condition can be referred to as the two high-ranking business-related elements that are used most frequently during the operation of that business file.

Subsequently, the operation log collection server 3 creates a business file determination condition list 41 as shown in FIG. 7 in which all business file determination conditions determined for each business file are registered. The business file determination condition list 41 is configured by comprising, as shown in FIG. 7, a business file determination condition ID column 41A and a business file determination condition column 41B. The business file determination condition ID column 41A stores the identifier (business file determination condition ID) that is assigned to the corresponding business file determination condition and which is unique to that business file determination condition. The business file determination condition column 41B stores the combination of the business-related elements configuring the corresponding business file determination condition.

The operation log collection server 3 thereafter sends the thus created business file determination condition list 41 and the foregoing business file list 23 (FIG. 4) to the respective client terminals 4.

Meanwhile, the client terminal 4 refers to the business file list 23 each time an operation is performed to an existing file, and determines whether that file is a business file (whether the file name of that file is registered in the business file list 23). The client terminal 4 sends to the operation log collection server 3, only upon determining that the file is a business file, the operation logs related to the business file and the operation logs related to the business-related elements of the business file that were operated during the operation of that business file.

Moreover, when a file (new file) is newly created, the client terminal 4 detects that files or sites that were accessed during the creation of such new file (these are hereinafter referred to as the “new file-related elements”) according to the same method described above with reference to FIG. 5. Specifically, the client terminal 4 groups the operation logs of processes in which the running period overlaps with the file open period of the new file and which include a file name and a site URL into groups (related operation log groups) RG having the same process ID, and respectively detects the files and sites that are subject to the corresponding process for each related operation log group RG. Subsequently, the client terminal 4 detects as the new file-related elements of the new file, among the thus detected files and sites, the files and sites corresponding to the process in which sequential operations were performed with a process during the file open period of the selected new file.

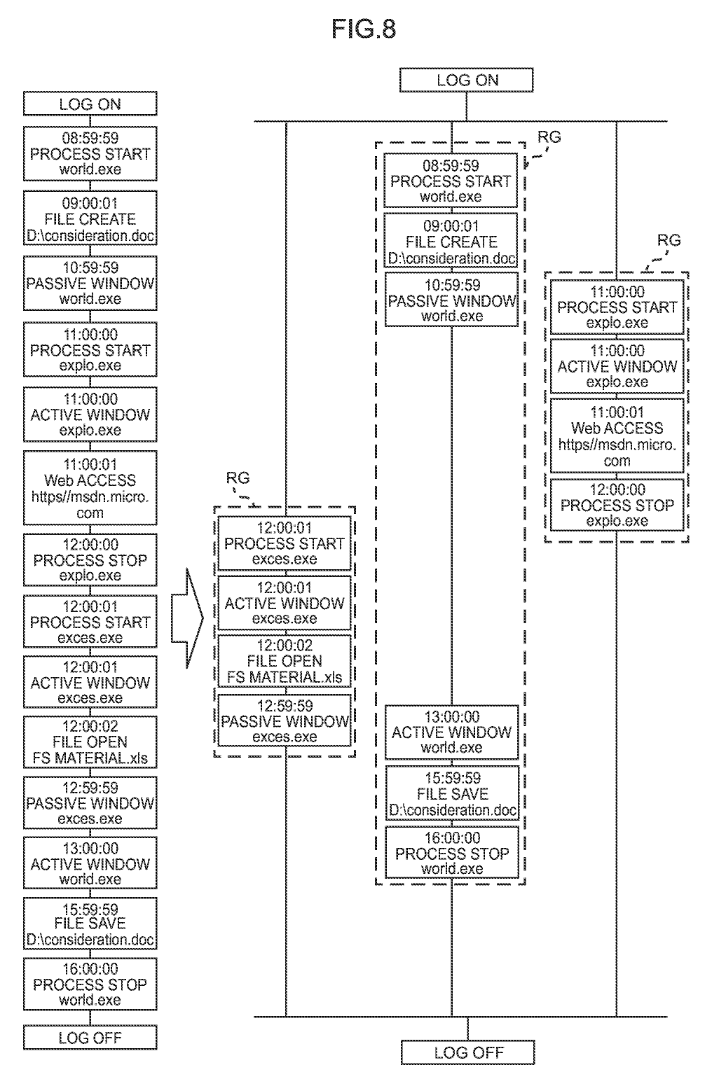

For example, FIG. 8 shows an example of an operation log that is generated upon the creation of a new file named “Consideration.doc” in the client terminal 4 while referring the a file named “FS Material.xls” and a website having a URL of “https://msdn.micro.com”. In FIG. 8, similar to FIG. 5, “exces.exe” represents an EXE file of spreadsheet software (“exces”), “world.exe” represents an EXE file of document production software (“world”), and “explo.exe” represents an EXE file of internet browsing software (“explo”).

In the foregoing case, because the processes in which the running period overlaps with the file open period of the new file named “Consideration.doc” are only the process when the file named “FS Material.xls” was opened and the process when the website having a URL of “https://msdn.micro.com” was browsed, the operation logs of these two processes are acquired, and these two operation logs are respectively grouped as a related operation log group RG. Moreover, for both the process when the file named “FS Material.xls” was opened and the process when the website having a URL of “https://msdn.micro.com” was browsed, the screen was switched with the process of the business file named “Consideration.doc”, and sequential operations with the process of the business file were performed. Accordingly, in this example, the file named “FS Material.xls” and the website having a URL of “https://msdn.micro.com” are detected as the new file-related elements of the new file named “Consideration.doc”.

When the combination of the new file-related elements of the new file detected as described above includes a combination of the two business-related elements configuring any one of the business file determination conditions registered in the business file determination condition list 41, the client terminal 4 determines that the new file is a business file, and sends, to the operation log collection server 3, the operation logs related to the new file obtained upon the creation of that new file, and the operation logs related to all new file-related elements that were accessed during the creation of that new file.

Furthermore, the client terminal 4 registers the new file as a business file in the business file list that it retains internally, and notifies the operation log collection server 3 that the new file is a business file. Consequently, the operation log collection server 3 registers the new file as a business file in the business file list 23 (FIG. 4) that it retains internally based on the foregoing notice, and notifies the respective client terminals 4 that the new file is a business file. Subsequently, each client terminal 4 that received the foregoing notice register the new file as a business file in the business file list 23 that it retains internally.

Meanwhile, when the combination of the new file-related elements of the new file detected as described above does not include any combination of the two business-related elements configuring any one of the business file determination conditions registered in the business file determination condition list 41, the client terminal 4 determines that the new file is not a business file. Accordingly, at this stage, the client terminal 4 does not send the operation logs related to the new file, which were obtained upon the creation of the new file, to the operation log collection server 3. However, the client terminal 4 thereafter continues to similarly monitor the operation logs related to the new file and, at the stage that the client terminal 4 determines that the new file is a business file, the client terminal 4 sends, to the operation log collection server 3, the operation logs related to the new file obtained upon the creation of that new file, and the operation logs related to all new file-related elements that were accessed during the creation of that new file.

Note that, in the operation log collection method according to this embodiment described above, if a file or a site that is frequently used normally, and not just during the operation of the business file, such as the home page or a portal site of a search engine, is included as one of the business-related elements configuring the business file determination condition created by the operation log collection server 3, there is a possibility that the detection accuracy of the business file by the client terminal 4 may deteriorate.

This is because the operation log collection method according to this embodiment is a method of extracting, as a business file determination condition, a combination of several business-related elements that are most frequently used during the operation of the business file, and estimating a new file to be a business file when all business-related elements configuring the business file determination condition upon the creation of the new file.

Accordingly, when a business-related element that is frequently used other than during the operation of the business file is included in the business file determination condition, it is difficult to identify that the new file is a business file only based on the use of such business-related element and, consequently, there is a possibility that this may result in an estimation accuracy that is equivalent to the case of determining whether or not the new file is a business file based on the remaining business-related elements configuring the business file determination condition.

Thus, with the operation log collection system of this embodiment, the system administrator is able to register in advance, in the operation log collection server 3, a business-related element that should be excluded from the business-related elements configuring the business file determination condition (this is hereinafter referred to as the “business file determination condition exclusion element”) even if it is frequently used during the operation of the business file. Consequently, the operation log collection system 1 is able to prevent the deterioration in accuracy when the client terminal 4 determines whether or not a new file is a business file.

As means for realizing the log collection method according to this embodiment as described above, as shown in FIG. 1, a manager 20 is stored in the memory 11 of the operation log collection server 3, and a business environment management table 22 and a business file determination condition exclusion element management table 24 are stored in the auxiliary storage device 12 of the operation log collection server 3 in addition to the operation log-related definition table 21 (FIG. 2) and the business file list 23 (FIG. 4) described above. Moreover, an agent 40 is stored in the memory 31 of each client terminal 4, and a business file determination condition list 41 is stored in the business file determination condition list 41 of each client terminal 4 in addition to the operation log-related definition table 21 and the business file list 23 described above.

The manager 20 is a program with a function of executing various types of processing to be performed by the operation log collection server 3 in relation to the operation log collection method according to this embodiment.

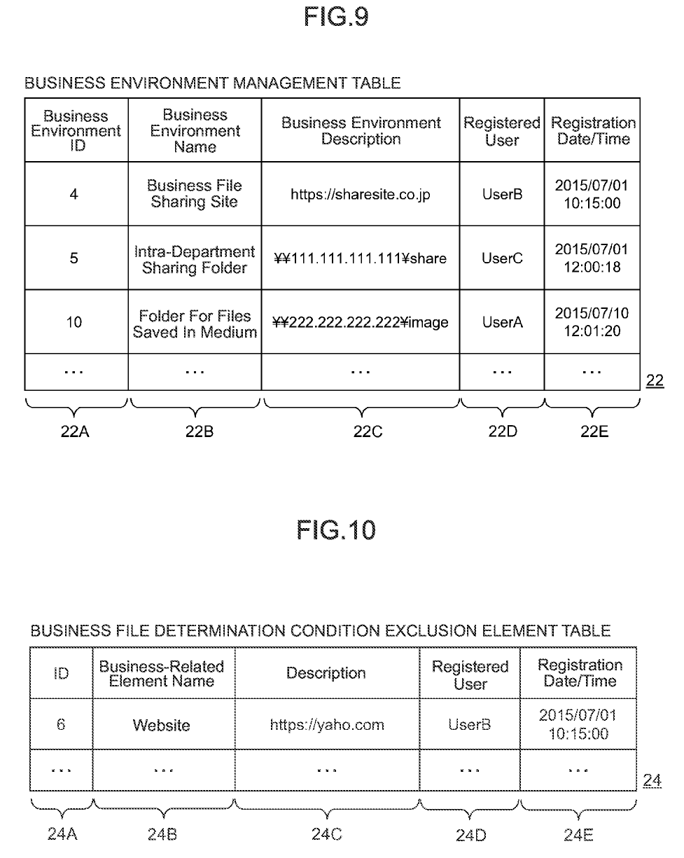

The business environment management table 22 is a table that is used by the system administrator for managing the registered business environments as described above. The business environment management table 22 is configured by comprising, as shown in FIG. 9, a business environment ID column 22A, a business environment name column 22B, a business environment description column 22C, a registered user column 22D and a registration date/time column 22E.

The business environment ID column 22A registers the identifier (business environment ID) that is assigned to the corresponding registered business environment and which is unique to that business environment. Note that the business environment ID may be assigned by the system administrator who registered the corresponding business environment, or automatically assigned by the operation log collection server 3.

The business environment name column 22B stores the name of the business environment (business environment name) that was input by the system administrator upon registering the corresponding business environment, and the business environment description column 22C stores the description of the corresponding business environment. Specifically, when the corresponding business environment is an internal IP address, that internal IP address is stored in the business environment description column 22C, when the corresponding business environment is a URL of an internal file sharing site, that URL is stored in the business environment description column 22C, and when the corresponding business environment is a business email address, that email address is stored in the business environment description column 22C.

The registered user column 22D stores the user name of the system administrator who registered the corresponding business environment, and the registration date/time column 22E stores the date/time that the business environment was registered.

Accordingly, the example depicted in FIG. 9 shows that, with regard to the business environment having a business environment ID of “4” that was registered by the system administrator named “User B” on “2015/07/01” at “10:15:00”, the business environment name is “business file sharing site”, and the business environment description (URL of that site in this example) is “https://sharesite.co.jp”.

The business file determination condition exclusion element management table 24 is a table that is used by the system administrator for managing the registered business file determination condition exclusion element as described above, and is configured by comprising, as shown in FIG. 10, a business-related element ID column 24A, a business-related element name column 24B, a description column 24C, a registered user column 24D and a registration date/time column 24E.

The business-related element ID column 24A stores an identifier (business-related element ID) that is assigned to the corresponding business-related element to become the business file determination condition exclusion element and which is unique to that business-related element, and the business-related element name column 24B stores the name (business-related element name) of that business-related element.

The description column 24C stores the description (file name or site URL) of the corresponding business-related element, and the registered user column 24D stores the user name of the system administrator who registered that business file determination condition exclusion element. The registration date/time column 24E stores the date/time that the business file determination condition exclusion element was registered.

Accordingly, the example depicted in FIG. 10 shows that the “Website” of “http://yaho.com” having a business-related element ID of “6” was registered as a business file determination condition exclusion element by a user named “User B” on “2015/07/01” at “10:15:00”.

The agent 40 is a program with a function of various types of processing to be performed by the client terminal 4 related to the operation log collection method according to this embodiment as described above.

### (3) CONFIGURATION OF VARIOUS TYPES OF DISPLAY SCREENS

### (3-1) Business Environment Registration Screen

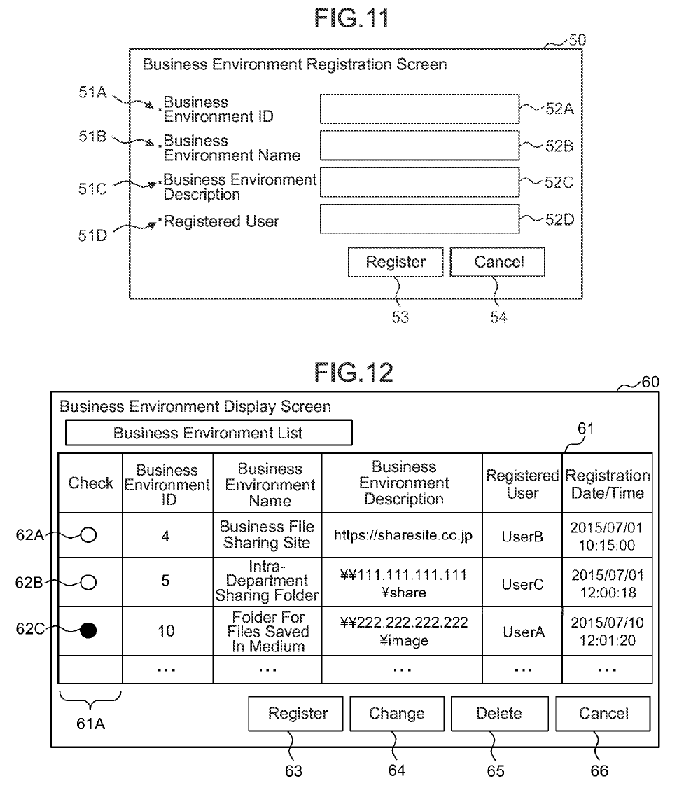

FIG. 11 shows a configuration example of a business environment registration screen 50 that can be displayed on the management console 2 (FIG. 1) by performing predetermined operations to the management console 2. The system administrator can use the business environment registration screen 50 to register the foregoing business environment in the operation log collection server 3.

In effect, the business environment registration screen 50 displays the respective character strings 51A to 51D of “business environment ID”, “business environment name”, “business environment description” and “registered user” as well as text boxes 52A to 52D in correspondence with the business environment ID, the business environment name, the business environment description and the registered user name (refer to FIG. 9) which are descriptions to be registered as the business environment. Moreover, a registration button 53 and a cancellation button 54 are displayed at the lower part of the business environment registration screen 50.

Subsequently, the system administrator can respectively input the corresponding information among the business environment ID, the business environment name, the business environment description and one's own user name of the business environment to be registered in the text boxes 52A to 52D corresponding respectively to the business environment ID, the business environment name, the business environment description and the registered user name, and thereby register that business environment by subsequently clicking the registration button 53. Information related to the registered business environment is sent from the management console 2 to the operation log collection server 3, and, within the operation log collection server 3, stored in the business environment management table 22 (FIG. 9) and managed by the manager 20.

Moreover, the system administrator can close the business environment registration screen 50 by clicking the cancellation button 54. Here, for example, when information was input in the respective text boxes 52A to 52D, such information is deleted.

### (3-2) Business Environment Display Screen

Meanwhile, FIG. 12 shows a configuration example of a business environment display screen 60 that may be displayed on the management console 2 (FIG. 1) by performing predetermined operations to the management console 2. The business environment display screen 60 is a screen for confirming the previously registered business environments, and changing or deleting the registered business environment as needed.

In effect, the business environment display screen 60 is configured by comprising a business environment list 61. The business environment list 61 displays information of all business environments registered in the business environment management table 22 retained by the operation log collection server 3. Note that this information was acquired from the operation log collection server 3 by the management console 2.

The business environment list 61 is configured in the same manner as the business environment management table 22 described above with reference to FIG. 9 excluding the point that a check column 61A is provided to each line. Radio buttons 62A to 62C are respectively displayed on the check column 61A of each line, and, by clicking and selecting one radio button 62A to 62C among the radio buttons 62A to 62C, the system administrator can select the business environment corresponding to the radio button 62A to 62C among the business environments in which various types of information are displayed in the business environment list 61. Here, only information related to the business environment (line of that business environment) corresponding to the radio button 62A to 62C is effectively displayed, and information corresponding to other business environments (lines corresponding to other business environments) are ineffectively displayed, within the business environment list 61.

Moreover, a registration button 63, a change button 64, a deletion button 65 and a cancellation button 66 are displayed at the lower part of the business environment display screen 60. Subsequently, on the business environment display screen 60, by the system administrator selecting the intended business environment as described above among the business environments in which information is displayed in the business environment list 61 and clicking the change button 64 in such selected state, the system administrator can change the information corresponding to that business environment in the business environment list 61. Moreover, on the business environment display screen 60, by the system administrator selecting the selecting the intended business environment as described above among the business environments in which information is displayed in the business environment list 61 and clicking the deletion button 65 in such selected state, the system administrator can delete the information of that business environment (delete the line corresponding to that business environment) from the business environment list 61.

Furthermore, on the business environment display screen 60, by the system administrator clicking the registration button 63 after updating (changing or deleting) the description of the business environment list 61 as described above, the system administrator can similarly update the description of the business environment management table 22 retained by the operation log collection server 3. In effect, when the system administrator clicks the registration button 63 after updating the business environment list 61 as described above, the management console 2 notifies the description of the updated business environment list 61 to the operation log collection server 3. Subsequently, upon receiving the foregoing notice, the manager 20 of the operation log collection server 3 updates the business environment management table 22 (FIG. 9) according to the description thereof.

Note that, by clicking the cancellation button 66, the system administrator can close the business environment display screen 60 without updating the description of the business environment management table 22 retained by the operation log collection server 3.

### (3-3) Business File Determination Reason Display Screen

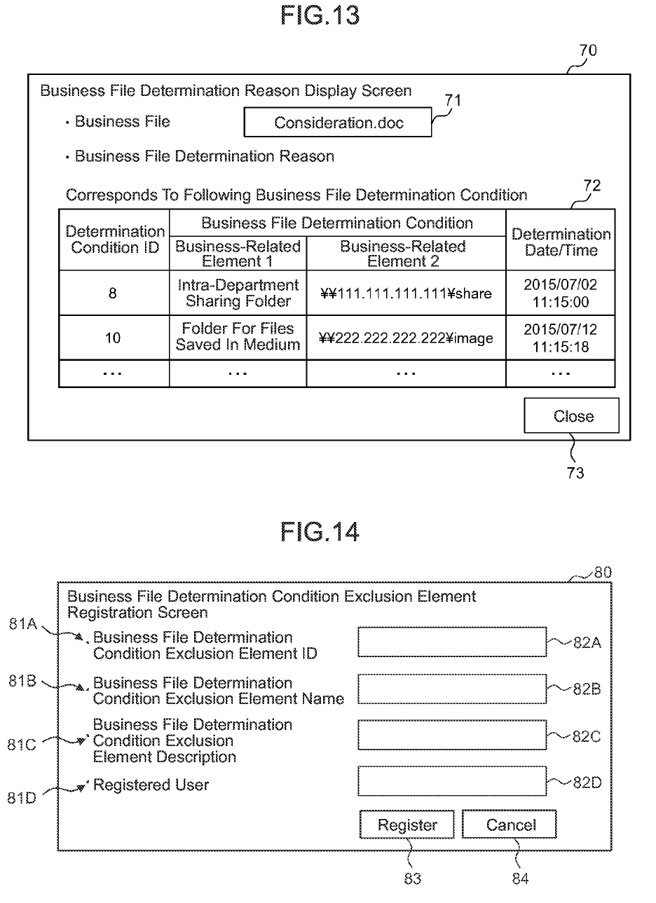

Meanwhile, FIG. 13 shows a configuration example of a business file determination reason display screen 70 that may be displayed on the management console 2 by performing predetermined operations to the management console 2. The business file determination reason display screen 70 is a screen for displaying the reason why the file was determined to be a business file by the operation log collection server 3 so that the system administrator can confirm the displayed reason.

In effect, the business file determination reason display screen 70 is configured by comprising a text box 71 for designating the target file (business file), and a business file determination condition list 72.

By the system administrator inputting the file name of the intended file in the text box 71, the business file determination reason display screen 70 can display, in the business file determination condition list 72, information of all business file determination conditions that were applied when that file was determined to be a business file.

Specifically, the business file determination condition list 72 displays, with regard to the respective business file determination conditions that were used when that file was determined to be a business file, a business file determination condition ID thereof (“determination condition ID”), a combination of the business-related elements configuring that business file determination condition (“business file determination condition”), and the date/time that the determination was made using that business file determination condition (“determination date/time”). Note that the foregoing information was acquired from the operation log collection server 3 by the management console 2 upon displaying the business file determination reason display screen 70.

The business file determination reason display screen 70 can be closed by clicking the close button 73 displayed at the lower part of the screen.

### (3-4) Business File Determination Condition Exclusion Element Registration Screen

FIG. 14 shows a configuration example of a business file determination condition exclusion element registration screen 80 that can be displayed by performing predetermined operations to the management console 2 (FIG. 1). The business file determination condition exclusion element registration screen 80 is a screen to be used by the system administrator for registering the foregoing business file determination condition exclusion element in the operation log collection server 3.

In effect, the business file determination condition exclusion element registration screen 80 displays character strings 81A to 81D of “business file determination condition exclusion ID”, “business file determination condition exclusion element name”, “business file determination condition exclusion element description” and “registered user”, as well as text boxes 82A to 82D, which respectively correspond to the identifier (business file determination condition exclusion element ID), the name (business file determination condition exclusion element name), the description (business file determination condition exclusion element description) and the registered user name (refer to FIG. 10) of the business file determination condition exclusion element to be registered. Moreover, a registration button 83 and a cancellation button 84 are displayed at the lower part of the business file determination condition exclusion element registration screen 80.

Subsequently, the system administrator can respectively input the corresponding information among the ID, the name, and the description of the business file determination condition exclusion element to be registered, as well as one's own user name, in the text boxes 82A to 82D corresponding respectively to the business environment ID, the business file determination condition exclusion element ID, the business file determination condition exclusion element name, the business file determination condition exclusion element description and the registered user name, and thereby register that business file determination condition exclusion element by subsequently clicking the registration button 83. Information related to the registered business file determination condition exclusion element is sent from the management console 2 to the operation log collection server 3, and, within the operation log collection server 3, stored in the business file determination condition exclusion element management table 24 (FIG. 10) and managed by the manager 20.

Moreover, the system administrator can close the business file determination condition exclusion element registration screen 80 by clicking the cancellation button 84. Here, for example, when information was input in the respective text boxes 82A to 82D, such information is deleted.

### (3-5) Warning Screen

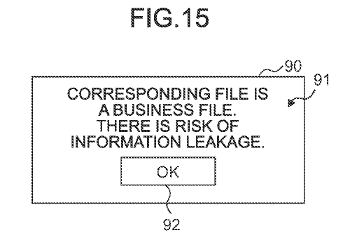

FIG. 15 shows a configuration example of a warning screen 90 that is displayed on the client terminal 4 when the user attempts to attach a business file to an email and send such email to an email address other than a business email address, or when the user attempts to upload a business file to a site or a folder that is not a business environment. The warning screen 90 is a screen for warning the user attempting to perform the foregoing operation that the file is a business file and, in certain cases, it may lead to the leakage of information.

In effect, the warning screen 90 displays a warning message 91 to the effect of “The corresponding file is a business file. There is risk of information leakage.” An OK button 92 is also displayed on the warning screen 90. The user can close the warning screen 90 by clicking the OK button 92.

### (4) VARIOUS TYPES OF PROCESSING RELATED TO OPERATION LOG COLLECTION METHOD OF THIS EMBODIMENT

Next, the specific processing contents of the various types of processing that are executed in relation to the operation log collection method according to this embodiment are now explained. Note that, in the ensuing explanation, while the processing entity of the various types of processing is explained as the manager 20 or the agent 40, in effect, it goes without saying that the CPU 10 (FIG. 1) of the operation log collection server 3 executes the processing based on the manager 20 or the CPU 30 (FIG. 1) of the client terminal 4 executes the processing based on the agent 40.

### (4-1) Business File Determination Condition List Distribution Processing

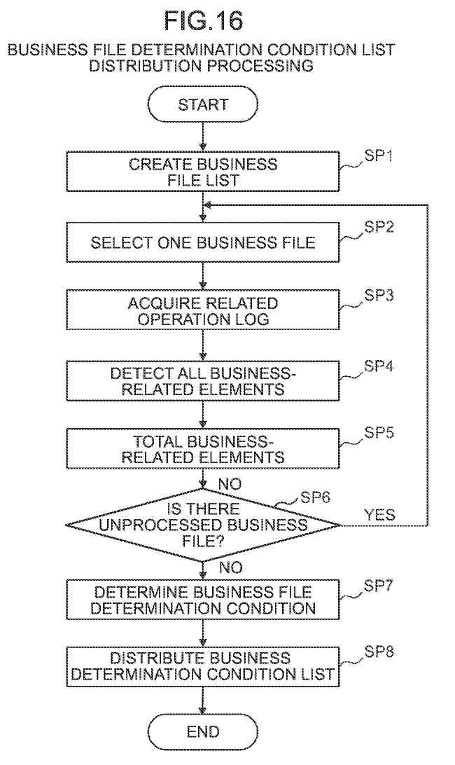

FIG. 16 shows the processing routine of the business file determination condition list distribution processing that is periodically executed by the manager 20 of the operation log collection server 3 in relation to the operation log collection method of this embodiment. In accordance with the processing routine shown in FIG. 16, the manager 20 creates the foregoing business file determination condition list 41 (FIG. 7), and distributes (sends) the created business file determination condition list 41 to the respective client terminals 4.

In effect, when the manager 20 starts the business file determination condition list distribution processing, the manager 20 foremost refers to the business environment management table 22 (FIG. 9) and the operation log database 25 (FIG. 1), and creates the business file list 23 (FIG. 4) in which all business files operated within the most recent fixed period are registered (SP1).

Subsequently, the manager 20 selects one business file among the business files registered in the business file list 23 that has not yet been subject to the processing of step SP3 onward, and creates the number of appearances counter table CT, which was described above with reference to FIG. 6, of the initial state of that business file (SP2).

Moreover, the manager 20 acquires from the operation log database 25, as the related operation logs, the operation logs of all processes in which the running period overlaps with the file open period of the business file selected in step SP2 (this is hereinafter referred to as the “selected business file”) and which include a file name and a site URL (SP3), and detects all business-related elements of the selected business file according the procedures described above with reference to FIG. 5 based on the acquired related operation logs (SP4).

Next, when the detected business-related element has previously been registered in the number of appearances counter table CT created in step SP2, the manager 20 adds one (increments) the count value corresponding to that business-related element, and, when the business-related element is not registered in the number of appearances counter table CT, newly registers that business-related element in the number of appearances counter table CT with a count value of 1 (SP5).

Subsequently, the manager 20 determines whether the processing of step SP3 to step SP5 has been executed regarding all business files registered in the business file list 23 (SP6). The manager 20 returns to step SP2 upon obtaining a negative result in the foregoing determination, and thereafter repeats the processing of step SP2 to step SP6 while sequentially switching the selected business file to another unprocessed business file in step SP2.

When the manager 20 eventually obtains a positive result in step SP6 as a result of executing the processing of step SP3 to step SP6 regarding all business files registered in the business file list 23, the manager 20 refers to each number of appearances counter table CT and determines the business file determination condition for each business file (SP7).

Specifically, the manager 20 extracts the two highest-ranking business-related elements with the greatest count value in the number of appearances counter table CT other than the business-related elements registered in the business file determination condition exclusion element management table 24 (FIG. 10) regarding each number of appearances counter table CT, and determines the combination thereof as the business file determination condition.

Subsequently, the manager 20 creates the business file determination condition list 41 (FIG. 7) in which all business file determination conditions determined in step SP7 as described above are registered, distributes, to the respective client terminals 4, the created business file determination condition list 41 and the business file list 23 retained by the operation log collection server 3 (SP8), and thereafter ends the business file determination condition list distribution processing.

### (4-2) Business File Determination Processing

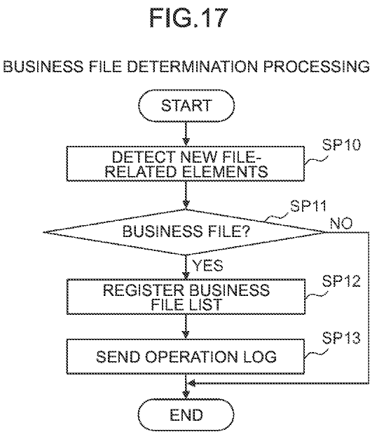

Meanwhile, FIG. 17 shows the processing routine of the business file determination processing to be executed by the agent 40 (FIG. 1) of the client terminal 4 when a new file is created in relation to the operation log collection method according to this embodiment. The agent 40 determines whether the created new file is a business file according to the processing routine shown in FIG. 17, and sends, to the operation log collection server 3, the required operation logs upon determining that the created new file is a business file.

In effect, when a new file is created, the agent 40 starts the business file determination processing, and foremost detects all new file-related elements of the new file according to the processing routine described above with reference to FIG. 8 (SP10).

Subsequently, the agent 40 determines whether the new file is a business file based on the new file-related elements of the new file detected in step SP10. Specifically, the agent 40 determines whether the combination of the new file-related elements of the new file detected in step SP10 includes the combination of the two business-related elements configuring any one of the business file determination conditions registered in the business file determination condition list 41 (SP11).

Subsequently, the agent 40 ends the business file determination processing upon obtaining a negative result in the foregoing determination. Accordingly, in the foregoing case, operation logs are not sent from the client terminal 4 to the operation log collection server 3.

Meanwhile, when the agent 40 obtains a positive result in step SP11, the agent 40 registers the new file in the business file list 23 retained by the corresponding client terminal 4, and notifies the operation log collection server 3 that the new file is a business file (SP12).

The agent 40 thereafter sends, to the operation log collection server 3, the operation logs regarding the new file that were generated upon the creation of that new file, and the operation logs regarding the business-related elements of that new file (SP13), and then ends the business file determination processing.

Note that, when the agent 40 obtains a negative result in the determination of step SP11, the agent 40 continues to similarly monitor the new file. Specifically, the agent 40 executes the business file determination processing shown in FIG. 17 each time that a file operation is performed to that new file.

### (5) EFFECT OF THIS EMBODIMENT

With the operation log collection system 1 of this embodiment described above, the operation log collection server 3 detects all business files used during the most recent fixed period based on the operation logs and generates the business file list 23 in which those business files are registered, detects the combination of two high-ranking business-related elements that are most frequently used during the operation of the business file as the business file determination conditions for each business file, creates the business file determination condition list 41 as the list thereof, and distributes the business file list 23 and the business file determination condition list 41 to the respective client terminals 4. Moreover, the client terminal 4 refers to the business file list 23 and the business file determination condition list 41 and determines whether a new file is a business file upon the creation of the new file, and sends, to the operation log collection server, the operation logs related to the new file when it is determined that the new file is a business file and the operation logs related to the business-related elements of that new file.

Thus, according to the operation log collection system 1 of this embodiment, the client terminal 4 can determine whether or not a new file is a business file with a certain level of accuracy, and the operation log collection server 3 can appropriately collect only the operation logs related to the business file and its business-related elements. Consequently, according to the operation log collection system 1 of this embodiment, it is possible to reliably collected required operation logs while protecting personal information.

Moreover, according to the operation log collection system 1 of this embodiment, because the operation log collection server 3 selectively collects only the operation logs related to the business file and its business-related elements, it is possible to dramatically reduce the number of operation logs to be collected by the operation log collection server 3, and it is consequently possible to reduce the amount of resources (network band and storage medium for retaining the operation logs in the operation log collection server 3) required for the operation log collection server 3 to collect and retain operation logs.

### (6) OTHER EMBODIMENTS

Note that, in the foregoing embodiment, while a case was explained where the client terminal 4 sends, to the operation log collection server 3, only the operation logs related to the business file and its business-related elements, the present invention is not limited thereto, and, for example, it is also possible to provide a storage device on the first or second network 5, 6 separately from the operation log collection server 3 and the client terminal 4, wherein each client terminal 4 accumulates all generated operation logs in the storage device, and the storage device sends to the operation log collection server 3, or the operation log collection server 3 reads from the storage device, only the operation logs related to the business file and its business-related elements among the foregoing operation log when necessary.

Moreover, in the foregoing embodiment, while a case was explained where, in step SP3 of the business file determination condition list distribution processing described above with reference to FIG. 16, all operation logs of all processes in which the running period overlaps with the file open period of the selected business file and which include a file name and a site URL are acquired as related operation logs from the operation log database 25, the present invention is not limited thereto, and the related operation logs may also be acquired in units of business divisions or business groups. It is thereby possible to improve the accuracy of the business file determination condition to be subsequently created.

Furthermore, in the foregoing embodiment, while a case was explained where the business file determination condition is a combination of two business-related elements, the present invention is not limited thereto, and the business file determination condition may also be a combination of three or more business-related elements. However, when the number of business-related elements configuring the business file determination condition is set to be three or more business-related elements, because a new file is not determined to be a business file unless all of the business-related elements are used upon the creation of that new file, there is a possibility that many new files will not be determined to be a business file even though they are actually a business file. Accordingly, by causing the business file determination condition to be a combination of two business-related elements, while there is a possibility that many new files will not be determined to be a business file even though they are actually a business file, it is possible to reduce, as much as possible, the number of new files that are determined as not being a business file even though they are actually a business file.

### INDUSTRIAL APPLICABILITY

The present invention can be broadly applied to operation log collection systems for collecting operation logs generated by the terminals in an information processing system of companies and the like that introduced BYOD or BYCD.

### REFERENCE SIGNS LIST

1 . . . operation log collection system, 2 . . . management console, 3 . . . operation log collection server, 4 . . . client terminal, 10, 30 . . . CPU, 20 . . . manager, 22 . . . business environment management table, 23 . . . business file list, 24 . . . business file determination condition exclusion element management table, 25 . . . operation log database, 40 . . . agent, 41 . . . business file determination condition list, 50 . . . business environment registration screen, 80 . . . business file determination condition exclusion element registration screen, 90 . . . warning screen, CT . . . number of appearances counter table, RG . . . related operation log group.

1. An operation log collection system including an operation log collection server and one or more client terminals and in which the operation log collection server collects operation logs generated in each of the client terminals,
wherein the operation log collection server:
periodically or randomly detects, based on the operation logs within a fixed period collected from each of the client terminals, all business files that were operated within the fixed period;
detects, for each of the detected business files, all files and sites that were subject to a process in which a running time overlaps with a process of a file open period of the business file and in which sequential operations were performed between the processes during the file open period of the business file, as business-related elements of the business file; and
determines for each of the business files, a combination of a predetermined number of high-ranking business-related elements which are most frequently used during operation of the business file as a business file determination condition, and distributes, to each of the client terminals, the business file determination condition determined for each of the business files, and
wherein the client terminal:
detects, based on the operation logs that were generated upon creation of a new file, all files and sites that were subject to a process in which a running time overlaps with a process of a file open period of the new file and in which sequential operations were performed between the processes during the file open period of the new file, as business-related elements of the new file; and
does not send the operation logs to the operation log collection server when a combination of the business-related elements of the new file does not include a combination of the business-related elements configuring any one of the business file determination conditions distributed from the operation log collection server, and sends, to the operation log collection server, the operation logs related to the new file and the operation logs related to each of the business-related elements of the new file when a combination of the business-related elements of the new file includes a combination of the business-related elements configuring any one of the business file determination conditions distributed from the operation log collection server.

2. The operation log collection system according to claim 1,
wherein the operation log collection server can register, as a business environment, at least one among an address of a folder used in business, an URL (Uniform Resource Locator) of a site used in business, and a business email address, and
wherein the operation log collection server detects as the business file, based on the operation logs within the fixed period, a folder of the address registered as the business environment, or a file downloaded from a site of the URL or uploaded to the folder or a site of the URL, or a file attached to the email address registered as the business environment within the fixed period.

3. The operation log collection system according to claim 1,
wherein the sequential operations performed between the processes are operations that were performed continuously for a fixed period mutually between the processes.

4. The operation log collection system according to claim 1,
wherein the business file determination condition is a combination of two high-ranking business-related elements which are most frequently used during operation of the corresponding business file.

5. The operation log collection system according to claim 1,
wherein the operation log collection server can register, as a business file determination condition exclusion element, the business-related element that should not be used as the business-related elements configuring the business file determination condition, and
wherein the operation log collection server determines as a business file determination condition, for each of the business files, a combination of the predetermined number of high-ranking business-related elements which are most frequently used during operation of the corresponding business file and which have not been registered as the business file determination condition exclusion element.

6. An operation log collection method to be executed in an operation log collection system including an operation log collection server and one or more client terminals and in which the operation log collection server collects operation logs generated in each of the client terminals, comprising:
a first step of the operation log collection server periodically or randomly detecting, based on the operation logs within a fixed period collected from each of the client terminals, all business files that were operated within the fixed period;
a second step of the operation log collection server detecting, for each of the detected business files, all files and sites that were subject to a process in which a running time overlaps with a process of a file open period of the business file and in which sequential operations were performed between the processes during the file open period of the business file, as business-related elements of the business file; and
a third step of the operation log collection server determining for each of the business files, a combination of a predetermined number of high-ranking business-related elements which are most frequently used during operation of the business file as a business file determination condition, and distributing, to each of the client terminals, the business file determination condition determined for each of the business files;
a fourth step of the client terminal detecting, based on the operation logs that were generated upon creation of a new file, all files and sites that were subject to a process in which a running time overlaps with a process of a file open period of the new file and in which sequential operations were performed between the processes during the file open period of the new file, as business-related elements of the new file; and
a fifth step of the client terminal not sending the operation logs to the operation log collection server when a combination of the business-related elements of the new file does not include a combination of the business-related elements configuring any one of the business file determination conditions distributed from the operation log collection server, and sending, to the operation log collection server, the operation logs related to the new file and the operation logs related to each of the business-related elements of the new file when a combination of the business-related elements of the new file includes a combination of the business-related elements configuring any one of the business file determination conditions distributed from the operation log collection server.

7. The operation log collection method according to claim 6,
wherein the operation log collection server can register, as a business environment, at least one among an address of a folder used in business, an URL (Uniform Resource Locator) of a site used in business, and a business email address, and
wherein, in the first step, the operation log collection server detects as the business file, based on the operation logs within the fixed period, a folder of the address registered as the business environment, or a file downloaded from a site of the URL or uploaded to the folder or a site of the URL, or a file attached to the email address registered as the business environment within the fixed period.

8. The operation log collection method according to claim 6,
wherein, in the fourth step, the sequential operations performed between the processes are operations that were performed continuously for a fixed period mutually between the processes.

9. The operation log collection method according to claim 6,
wherein the business file determination condition is a combination of two high-ranking business-related elements which are most frequently used during operation of the corresponding business file.

10. The operation log collection method according to claim 6,
wherein the operation log collection server can register, as a business file determination condition exclusion element, the business-related element that should not be used as the business-related elements configuring the business file determination condition, and
wherein, in the third step, the operation log collection server determines as a business file determination condition, for each of the business files, a combination of the predetermined number of high-ranking business-related elements which are most frequently used during operation of the corresponding business file and which have not been registered as the business file determination condition exclusion element.
